(19) United States
(12) Patent Application Publication
(10) Pub. No.: US 2019/0337338 A1
(43) Pub. Date: Nov. 7, 2019

(54) Tread Having Hidden Cavities

(71) Applicant: COMPAGNIE GENERALE DES ETABLISSEMENTS MICHELIN, Clermont-Ferrand (FR)

(72) Inventors: Tony ZIVKOVIC, Clermont-Ferrand (FR); Arnaud LARREGAIN, Clermont-Ferrand (FR)

(21) Appl. No.: 16/474,313

(22) PCT Filed: Dec. 19, 2017
(86) PCT No.: PCT/FR2017/053702

§ 371 Date: Jun. 27, 2019

(30) Foreign Application Priority Data
Dec. 28, 2016 (FR) 1663455

(51) Int. Cl. B60C 11/03

(52) U.S. Cl. CPC B60C 11/0323; B60C 2200/06

(57) ABSTRACT

Tread (1) for a heavy-duty vehicle tire having a total thickness corresponding to the thickness of material to be worn away during running, this tread having, in the new state, a tread surface (10) intended to come into contact with a roadway when running, this tread (1) comprising at least one hidden cavity (2) intended to form a new groove opening onto the tread surface after a predetermined amount of partial wear, this hidden cavity (2) comprising two opposite lateral walls (21, 22) connected together by a bottom (23) radially towards the inside and by a crown part (24) radially towards the outside, the tread according to invention being characterized in that the crown part (24) of the hidden cavity is provided with a plurality of fine ribs (25) extending radially towards the inside of the hidden cavity (2) from the crown part (24) delimiting the hidden cavity.

### FIELD OF THE INVENTION

The invention relates to treads for tires and more particularly to the tread pattern designs of these treads, and to the tires provided with such treads which have a lasting ability to drain away water present on the roadway in times of wet weather, these treads having improved running performance.

### PRIOR ART

As is known, wet-weather driving conditions require the most rapid possible elimination of the water between the tread of each tire and the roadway so as to ensure that the tread makes contact with the roadway. Water that is not pushed over the front of the tire flows partially along the grooves and sipes formed in the tire tread, whether these grooves and sipes are oriented in the circumferential direction or the transverse direction or in an oblique direction.

Definitions

A cut means any cavity or void made notably by moulding in a tread, this cut extending both in a main direction, which is the direction of flow of the water in the cut in wet weather, and into the depth of the tread.

A groove means here a cut that opens onto a tread surface intended to be in contact with the roadway, this cut having a mean width such that the walls of material delimiting it are never in contact with one another under the normal service conditions of the tire.

A sipe means here a thin cut having a mean width that is small and such that, under normal tire service conditions, the walls of material delimiting it can come at least partially into contact with one another when that sipe is in the contact patch in which the tire is in contact with the roadway.

A hidden groove means a cavity or channel formed at least partially under the tread surface in the new state, this hidden cavity or hidden channel being intended to form a new groove that is open onto the tread surface after a predetermined amount of partial wear. A hidden groove is delimited by two opposite lateral walls, these two lateral walls being connected together by a lower part forming a bottom connecting the two walls radially towards the inside and by an upper part in the continuation of these walls radially towards the outside. Into this upper part, a sipe connecting the hidden groove to the tread surface in the new state can open.

The thickness of material to be worn away means the thickness of tread that can be worn away during running before the legal tread wear limit, which can be indicated by wear indicators formed notably in the grooves, is reached.

In the present description, the terms radial or radially are used to indicate a direction which, when considered on the tire, is a direction perpendicular to the axis of rotation of the tire whereas, when considered on a tread alone, it corresponds to the direction of the thickness of said tread. Moreover, the term circumferential is used to indicate a direction which corresponds to a direction tangential to any circle centred on the axis of rotation of the tire. This same direction corresponds to the longitudinal direction of the tread, the latter being formed in the manner of a flat strip before it is incorporated at the time of manufacture of a tire.

Whatever the category of tire (that is to say whether it is a tire to be fitted to a passenger vehicle or to a heavy-duty vehicle intended to carry heavy loads), the tread needs to have a standing-water drainage performance that always remains above a minimum performance referred to as the safe performance. Accordingly, and given that the tread gradually wears away, progressively reducing the cross-sectional areas of the grooves and consequently the ability of these grooves to remove a volume of liquid, it is commonplace to produce grooves that open onto the tread surface in the new state and continue into the thickness of the tread down to at least a level that corresponds to a legal limit requiring the tread to be withdrawn.

The disadvantage of creating a plurality of grooves that open onto the tread surface of a tread in the new state is that it reduces the amount of tread material for a given width of tread and consequently has an appreciable impact on the stiffness of the tread and the wearing performance. As a result, in order to address the loadings experienced by the tread during running, a person skilled in the art needs to compensate for these reductions in stiffness by any means at their disposal, notably by adapting the internal structure of the tire, something that is, of course, not without its own impact on the cost price of the tire itself. These reductions in stiffness can also adversely affect the wear rate, the evenness of this wear, and some of the expected aspects of performance during running.

Moreover, an increase in rolling resistance has been observed, which manifests itself in an appreciable increase in fuel consumption of vehicles fitted with such tires, as a result of an increase in hysteresis losses associated with the cycles of deformation of the rubbery material of which the tread is made.

The document EP2483087-B1 proposes forming in a tread grooves that have the particular feature of opening discontinuously onto the tread surface in the new state. This groove can be considered to be a groove that is wavy in the thickness of the tread, opening regularly onto the tread surface. This type of groove that is wavy in the direction of the thickness of a tread can be formed either in the circumferential direction or in any other direction. As described in that publication, this type of groove is continuous in the initial state (which corresponds to the new state of the tread) so that, when driving on a roadway covered in standing water, water can be picked up in those parts of the groove that open onto the tread surface as they enter the contact patch, the water thus picked up being drained along the wavy groove beneath the tread surface. The liquid thus picked up is then ejected outside the contact patch under the effect of centrifugal forces. That same document describes the possibility, like prior-art tread pattern designs, of making connections between at least two wavy grooves of this type.

Other documents exist, such as, in particular, EP 2323858 B1, which recommend the formation of hidden voids formed entirely beneath the tread surface of the tread in the new state. That type of tire makes it possible to renew the drainage volume when the tread has reached a predetermined level of wear.

In all these solutions, it has been found that, before the formation of new grooves, localized wear can occur, this wear being able to be described as irregular since it does not arise uniformly over the entire tread. This can be explained by the fact that the portion of material radially between each hidden cavity and the tread surface is less stiff than the rest.

The document EP1015261 B1 proposed a solution for causing the virtually instantaneous appearance of a new groove from a hidden cavity. That means consists in the presence of two small cut grooves formed in the upper part of the cavity, these small cut grooves being continuous in the main direction of the hidden cavity. These small cut grooves extend radially towards the tread surface beyond the upper wall delimiting the cavity. When the level of wear reaches these cut grooves, the upper part of the cavity is instantaneously detached from the tread, thereby opening up the groove. However, while this arrangement makes it possible to rapidly form a new groove, it does not make it possible to avoid irregular wear before the upper part is completely detached from the tread. Moreover, this arrangement can cause a number of difficulties in demoulding the tire while it is being manufactured.

The following prior-art documents are also mentioned: FR 2971732 A1, WO 2015/114129 A1, FR 2940185 A1.

### BRIEF DESCRIPTION OF THE INVENTION

The present invention seeks to propose a solution to this problem of irregular wear that can occur before a new groove is formed by the opening of a hidden channel beneath the tread surface.

To this end, a subject of the invention is a tread for a heavy-duty vehicle tire having a thickness corresponding to the thickness of material to be worn away during running This tread has, in the new state, a tread surface intended to come into contact with a roadway when a tire provided with this tread is running This tread surface changes with wear.

The tread according to the invention comprises at least one hidden cavity intended to form a new groove opening onto the tread surface after a predetermined amount of partial wear. This hidden cavity comprises two opposite lateral walls that are spaced apart from one another by a distance corresponding to the width Lm of the new groove, these lateral walls being connected together by a lower part forming a bottom radially towards the inside and by an upper part radially towards the outside. This tread is such that the upper part delimiting the hidden cavity is provided with a plurality of fine ribs, the height of which extends radially towards the inside of the hidden cavity from the upper part delimiting said cavity.

Advantageously, these fine ribs extend in a mean direction that makes an angle at least equal to 40 degrees with the main direction of the hidden cavity.

The main direction of a cavity corresponds to the direction of flow of a liquid inside this cavity when it is open onto the tread surface and forms a new groove; it is generally the direction of the largest dimension of the cavity.

Advantageously, the maximum height of the fine ribs is chosen depending on the height Hc of the hidden cavity, this height being able to be fixed in advance depending on the thickness of tread material to be worn away. The maximum height of the fine ribs is modified depending on the height Hc of the hidden cavity. Preferably, the maximum height of the fine ribs is at least equal to 1 mm and at most equal to 5 mm.

Preferably, these fine ribs have a height at most equal to 30% of the thickness of material to be worn away. Preferably, these fine ribs have a height at least equal to 5% of the thickness of material to be worn away and at most equal to 30% of the same thickness.

In one variant of the invention, the fine ribs formed on the upper part delimiting the hidden cavity are oriented at an angle close or equal to 90 degrees to the main direction of the hidden cavity.

In one variant of the invention, the fine ribs extend as far as at least one lateral wall of the hidden cavity and continue on this lateral wall. Preferably, the fine ribs extend over the lateral walls of the hidden cavity over a height at least equal to 1.5 mm and at most equal to 5 mm and even more preferably at most equal to 3 mm.

In another variant of the invention, the upper part of the hidden cavity comprises, on each side of the sipe, a flat face inclined at an angle greater than zero and at most equal to 45 degrees, this angle being measured with respect to a direction parallel to the transverse direction.

By virtue of this invention, it is possible to locally modify the stiffness of the tread in the vicinity of each hidden cavity in a phase of wear fairly close to the formation of a new groove. This local modification of the stiffness ensures better wearing behaviour and it is thus possible to obtain a more regular wear profile of the tread before the appearance of a new groove compared with the same tread without small grooves as defined.

Further features and advantages of the invention will become apparent from the description given below with reference to the appended drawings which show, by way of non-limiting example, an embodiment of the subject matter of the invention.

### BRIEF DESCRIPTION OF THE FIGURES

FIG. 1 shows a partial view of the edge of a tread comprising a plurality of channels formed entirely beneath the tread surface in the new state, these channels being oriented transversely, i.e. parallel to the axis of rotation of the tire provided with this tread;

FIG. 2 shows a cross section on a plane containing the axis of rotation and the line of which is indicated by the line II-II in FIG. 1;

FIG. 3 shows a variant of a hidden channel according to the invention that is continued towards the tread surface by a sipe and comprises a plurality of fine ribs formed on the upper part of the hidden channel;

FIG. 4 shows a variant of the invention applied to a wavy groove having a succession of parts that are open onto the tread surface in the new state and hidden parts.

### DESCRIPTION OF THE FIGURES

The examples described below relate to heavy-duty vehicle tires of size 315/70R22.5. They can be transposed easily to heavy-duty vehicle tires of different sizes.

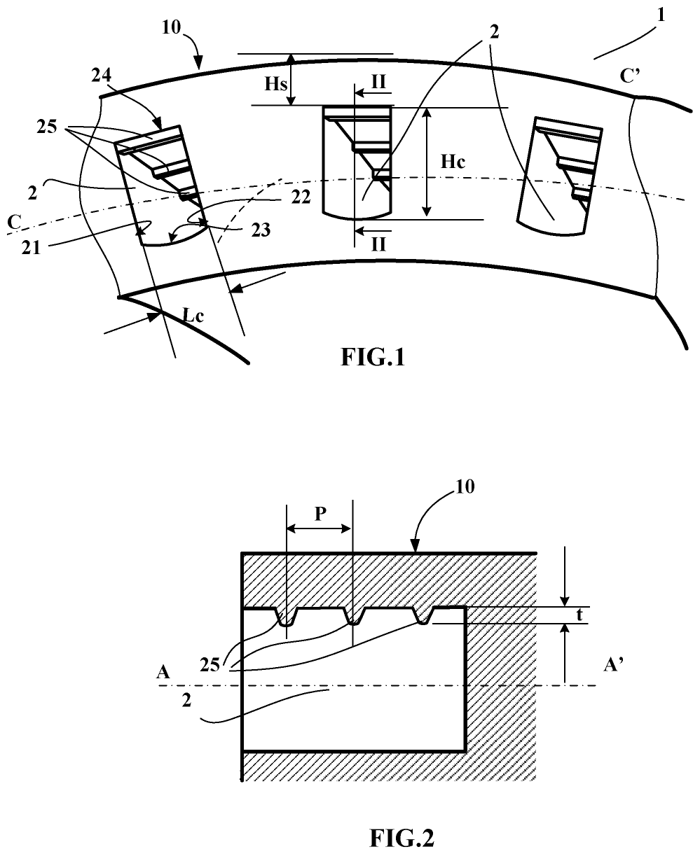

The first variant illustrating the invention is shown in FIG. 1 and relates to a tread 1 of a tire for a heavy-duty vehicle, this tread 1 having, in the new state, a tread surface 10 intended to come into contact with a roadway. This tread 1 comprises hidden channels 2 under the tread surface 10 that are intended, after the tread has been partially worn away, to form new grooves that open onto the tread surface. In the present case, these hidden channels 2 are oriented transversely, that is to say in a direction corresponding to the transverse or axial direction of a tire provided with this tread. The transverse direction is coincident with the axis of rotation of the tire.

As can be seen in FIG. 1, these hidden channels 2 open towards the outside at the lateral edges of the tread 1. Each hidden channel 2 comprises two opposite lateral walls 21, 22, the distance between these lateral walls defining the width Lc of the channel. These lateral walls 21 and 22 are connected together by a channel bottom 23 in the innermost part of the tread and by a crown part 24 in the part closest to the tread surface 10.

Located on each of the channels 2 and on the crown part 24 are a plurality of fine ribs 25 with a maximum height t equal to 4 mm, these fine ribs 25 being oriented perpendicularly with respect to the main direction of the channels 2. In the present case, the main direction of the channels corresponds to the transverse or axial direction on the tread, the latter direction corresponding to the direction perpendicular to the plane of FIG. 1.

Each channel 2 is situated beneath the tread surface 10 of the tread 1 at a distance Hs equal, in the present case, to 5 mm and has a total height Hc equal, in the case of the example, to 8 mm. The thickness of tread material to be worn away corresponds substantially to the sum of the heights Hs and Hc. The width Lc of the hidden channel 2 is equal to 6 mm.

FIG. 2 shows a cross section of the tread shown in FIG. 1 made in a radial section plane, that is to say a plane containing the axis of rotation of the tire. It is apparent in this section plane that the upper wall delimiting the hidden cavity 2 comprises a plurality of fine ribs with a maximum height t equal, in the example described, to 2 mm, these fine ribs being disposed regularly at a spacing P. These fine ribs have a maximum width equal to 1.5 mm The distance P between the fine ribs is between one and five times the maximum width Lc of the hidden cavity 2.

The fine ribs are oriented perpendicularly to the plane of FIG. 2, that is to say perpendicularly to the main direction of the hidden cavity 2 (the latter being indicated by the direction AA′ in FIG. 2).

In a variant that is not shown here, the fine ribs may be oriented obliquely so as to form an angle less than 90 degrees. Preferably, this angle is at least equal to 45 degrees.

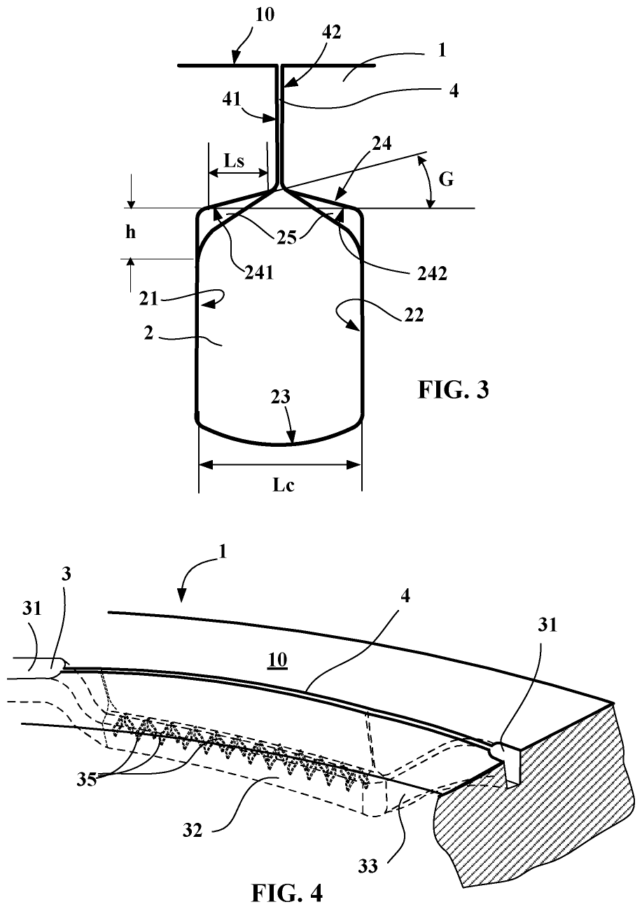

FIG. 3 shows a variant of the invention in which a channel 2 is continued towards the tread surface 10 by a sipe 4. In this variant, the crown part 24 of the channel 2 is subdivided on either side of the sipe 4 into two crown parts 241, 242. Each of these crown parts 241, 242 is inclined at an angle G equal to 15 degrees in the example, so as to form an angle of 150 degrees therebetween. Also formed on each of these crown parts 241, 242 are a plurality of transversely oriented fine ribs 25. These fine ribs 25 make an angle of 90 degrees with the main direction of the hidden cavity corresponding to the direction perpendicular to the plane of FIG. 3. These fine ribs 25 continue over a height h along the lateral faces 21, 22 delimiting the cavity 2. In the present case, this height h is equal to 2 mm.

The combination of the presence of a plurality of fine ribs 25 and the inclination G of the crown parts 241, 242 is particularly effective on the wearing surface before the formation of new grooves that open onto the tread surface.

The third variant, shown in FIG. 4, relates to a tread 1 for a heavy-duty vehicle tire of size 315/70R22.5.

This tread has, in its thickness, at least one groove referred to as wavy, this wavy groove 3 having an alternation of groove parts 31 that open onto the tread surface 10 in the new state and hidden cavities 32 that are intended to open onto the tread surface after a predetermined amount of wear in order to form new grooves. These open groove parts 31 and hidden cavity parts 32 are connected together by connecting parts 33 that ensure continuity of the flow of fluids in the wavy groove in the new state, this flow taking place in the main direction of the groove. This type of wavy groove is described in the patent EP2483087-B1, to which reference is made in particular for the figures contained in this cited patent.

The maximum width of the hidden cavity 32 is equal to 5 mm and its height is equal to 6 mm.

In order to make it easier to mould and demould this wavy groove 3, a sipe 4 is also formed that extends between each hidden cavity 32 and each connecting part 33 for connecting to the tread surface 10 in the new state. The sipe 4 has a width equal to 0.6 mm and is delimited by walls that are able to come into at least partial contact with one other under use conditions.

Each hidden part 32 comprises two opposite lateral walls, these lateral walls being connected together by a lower part forming the bottom radially on the inside and by an upper part radially on the outside. The upper part is divided into two parts that are continued by walls delimiting the sipe 4.

In order to improve the wearing surface radially above the hidden cavities and thus to achieve more regular wear over the entire tread surface, a plurality of fine ribs 35 are formed on the upper part of each hidden cavity, said fine ribs 35 being oriented in the present case so as to make an angle of 90 degrees with the main direction of the groove 3, this main direction corresponding to the direction of the flow of water in the groove 3 when running in wet weather.

These fine ribs 35 continue over a small height h (equal here to 1.5 mm) on the walls delimiting each hidden cavity 32 widthwise. These fine ribs 35 are disposed parallel to one another at a spacing equal to 6 mm.

After the tread has been partially worn away, and before the hidden cavity becomes a groove open onto the tread surface of the tread, the addition of material associated with the presence of these fine ribs causes localized stiffening in the vicinity of the cavity, making it possible to ensure more a more regular wearing surface.

The examples described are not intended to limit the invention and various modifications can be made thereto by a person skilled in the art without departing from the scope of the invention as defined in the claims.

1. A tread for a heavy-duty vehicle tire having a total thickness corresponding to the thickness of material to be worn away during running, the tread having, in the new state, a tread surface adapted to come into contact with a roadway when running, the tread comprising at least one hidden cavity configured to form a new groove opening onto the tread surface after a predetermined amount of partial wear, said hidden cavity comprising two opposite lateral walls connected together by a bottom radially towards the inside and by a crown part radially towards the outside, wherein the crown part of the hidden cavity has a plurality of fine ribs, the height of which extends radially towards the inside of the hidden cavity from the crown part delimiting the hidden cavity.

2. The tread according to claim 1, wherein said fine ribs extend in a direction that makes an angle at least equal to 40 degrees with the main direction of the cavity, the main direction of a cavity corresponding to the direction of flow of a liquid inside this cavity when it is open onto the tread surface.

3. The tread according to claim 1, wherein the fine ribs formed on the crown part delimiting the hidden cavity have a maximum height at least equal to 1 mm and at most equal to 5 mm.

4. The tread according to claim 1, wherein the fine ribs formed on the crown part delimiting the hidden cavity are oriented at an angle close or equal to 90 degrees to the main direction of the hidden cavity, the main direction of a cavity corresponding to the direction of flow of a liquid inside this cavity when it is open onto the tread surface.

5. The tread according to claim 1, wherein the hidden cavity is continued radially as far as the tread surface in the new state by a sipe (4).

6. The tread according to claim 5, wherein the upper part of the hidden cavity comprises, on each side of the sipe, a flat face inclined at an angle greater than zero and at most equal to 45 degrees, said angle being measured with respect to a direction parallel to the transverse direction.

7. The tread according to claim 1, wherein the fine ribs continue on a part of at least one of the lateral walls delimiting the hidden cavity.

8. The tread according to claim 7, wherein the height over which these fine ribs extend along at least one of the lateral walls is at least equal to 1.5 mm.

9. The tread according to claim 8, wherein the height over which these fine ribs extend along at least one of the lateral walls is at most equal to 3 mm.
